(19) United States
(12) Patent Application Publication
(10) Pub. No.: US 2008/0014848 A1
(43) Pub. Date: Jan. 17, 2008

(54) METHOD OF SETTING AND CONTROLLING COIN STORE OPERATING LEVELS

(75) Inventors: Joseph L. Levasseur, Chesterfield, MO (US); Mark Leibu, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: COIN ACCEPTORS, INC., St. Louis, MO (US)

(21) Appl. No.: 11/778,522

(22) Filed: Jul. 16, 2007

Related U.S. Application Data
(60) Provisional application No. 60/807,425, filed on Jul. 14, 2006.

(51) Int. Cl. G07D 9/00

(52) U.S. Cl. 453/16; 453/18; 453/39; 453/58

(57) ABSTRACT

A method of operating a coin changer comprising the steps of activating a visual display to show recommended operating levels for a plurality of coin stores and manually positioning level indicators associated with each of the plurality of coin stores to suggested operating levels displayed on the visual display.

The present application claims priority to U.S. Provisional Patent Application Ser. No. 60/807,425 that was filed Jul. 14, 2006. The contents of such application is incorporated herein by reference.

### FIELD OF THE INVENTION

The present invention relates generally to coin changers and more specifically to a method and apparatus to control desired levels of stores for payback in a coin changer.

### DESCRIPTION OF THE RELATED ART

During the past there have been numerous techniques and designs to manage the level of coins in coin stores for payout in a coin changer. In particular there have been devices located at various locations at the coin stores to detect the presence of coins to insure that coins are available for payout, to prevent overfilling and to limit the level of use. Various devices such as lever-operated switches, coin diverter levers to prevent overflow, optic devices, and coils have been utilized.

One way of controlling the level of coins in the coin stores of a coin changer is disclosed in U.S. Pat. No. 4,587,984 now expired and assigned to the present assignee. The '984 patent discloses monitoring the level of coins in one or more coin stores using no sensors at the coin stores. The invention accomplishes coin level monitoring for each tube by using a memory. A coin count in the memory is decremented when a coin is discharged during payout and incremented when a coin is added to a coin tube. When the memory count goes above set levels, the coins are diverted to a cash box rather than to a coin tube for payout as change. When the coin level is too low then no coin is to be discharged as change from that coin tube.

Another technique is disclosed in U.S. Pat. No. 4,774,841 which uses a short duration acoustic signal that is directed downward from the top of a coin store. The time for the signal to reflect back from the topmost coin held in the coin store relates to the height of the coin stack and is measured. This information is used to control the coin store levels and determine an approximate coin count for the coin store.

A method to alter the desired float level for coin stores is disclosed in European Patent Application Publication EP1031950A1 whereby manually adding or subtracting coins at each coin store is memorized as altered float levels for subsequent use. U.S. Pat. No. 6,623,349 discloses apparatus for enabling a float operation to automatically adjust the coin routing to or from the coin stores to leave a predetermined collective value of different denominations. Other disclosures relate to automatically adjusting the collective value of the coins and denominations to be utilized.

What is needed is an inexpensive method and system of change making that is simpler for an operator to initiate, maintain, and to reset. Simplicity is also needed for change making when providing greater capacity for any denomination and a greater number of denominations.

### SUMMARY OF THE INVENTION

The present invention provides a method of operating a coin changer comprising the steps of activating a visual display to show recommended operating levels for a plurality of coin stores and manually positioning level indicators associated with each of the plurality of coin stores to suggested operating levels displayed on the visual display.

### BRIEF DESCRIPTION OF THE DRAWINGS

Referring now to the drawings in which like reference numbers represent corresponding parts throughout:

FIG. 1 is a diagram of a coin changer incorporating six coin tubes according to an embodiment of the present invention;

FIG. 2 through 5 are diagrams of exemplary combinations of coin store denomination assignments and operating levels according to an embodiment of the present invention;

FIG. 6 is a diagram showing recommended initial coin store assignments for six coin stores at various sales prices according to an embodiment of the present invention;

FIG. 7 is a drawing of a coin acceptor having a display and operator activation buttons according to an embodiment of the present invention; and

FIG. 8 is a plan view of a coin store with a sliding level indicator according to an embodiment of the present invention.

### DETAILED DESCRIPTION OF PREFERRED EMBODIMENT

In the following description, reference is made to the accompanying drawings which form a part hereof, and which is shown, by way of illustration, several embodiments of the present invention. It is understood that other embodiments may be utilized and structural changes may be made without departing from the scope of the present invention.

The preferred embodiment of the present invention discloses a method and apparatus for an operator of a coin changer to manually activate a visual display of recommended coin store operating levels which is used to position level indicators that are attached to coin stores. The operator then discharges or adds coins for each coin store to those level indicators. This may be done by the operator removing or adding coins or by manually providing a signal to the coin changer to discharge coins. The operator then manually sets the coin store operating levels to zero for directing subsequent coin deposits to an appropriate coin store when it is at a level less than zero.

The visual display of recommended float levels is controlled by software which determines stored coin denomination proportions for a given sales price and the amount of coins to be assigned to each coin store based on the maximum expected product sales between restocking times. Recommended changes in operating levels are displayed for the operator based on previous activities regarding any minimum requirements reached during a past period of time.

Another feature provides the operator to indicate a total value of coins to be automatically discharged sequentially, one coin at a time from selected coin stores. Still another feature allows the operator to manually indicate a total value of coins for automatically increasing selected coin stores and to then set the operation levels to the new zero.

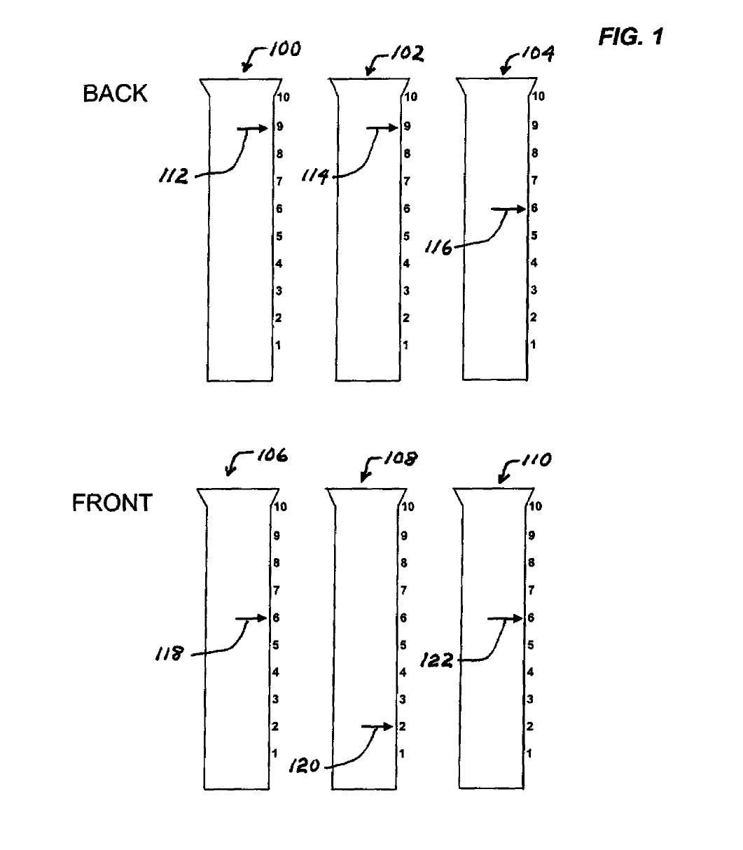

FIG. 1 is a drawing representing three coin stores 100, 102, and 104 which are behind three front coin stores 106, 108, and 110. Each of the six coin stores 100 through 110 have movable level indicators 112 through 122, respectively, which can be manually positioned at various levels by an operator. The moveable level indicators 112 through 122, or pointers, are placed at recommended coin operating levels for each coin store. Coin stores 100 and 102 are shown at level 9 by level indicators 112 and 114 respectively. Coin stores 104, 106, and 110 are shown at level 6 by level indicators 116, 118, and 122 respectively. Coin store 108 is shown at level 2 by level indicator 120. The coin stores 100 through 110 are made of transparent plastic to easily view the coin stack's relationship to the level 1 through 10 markings associated along each coin store 100 through 110. The movable indicators 112 through 122 are designed to be easily positioned and secured and to provide an easy visible reference.

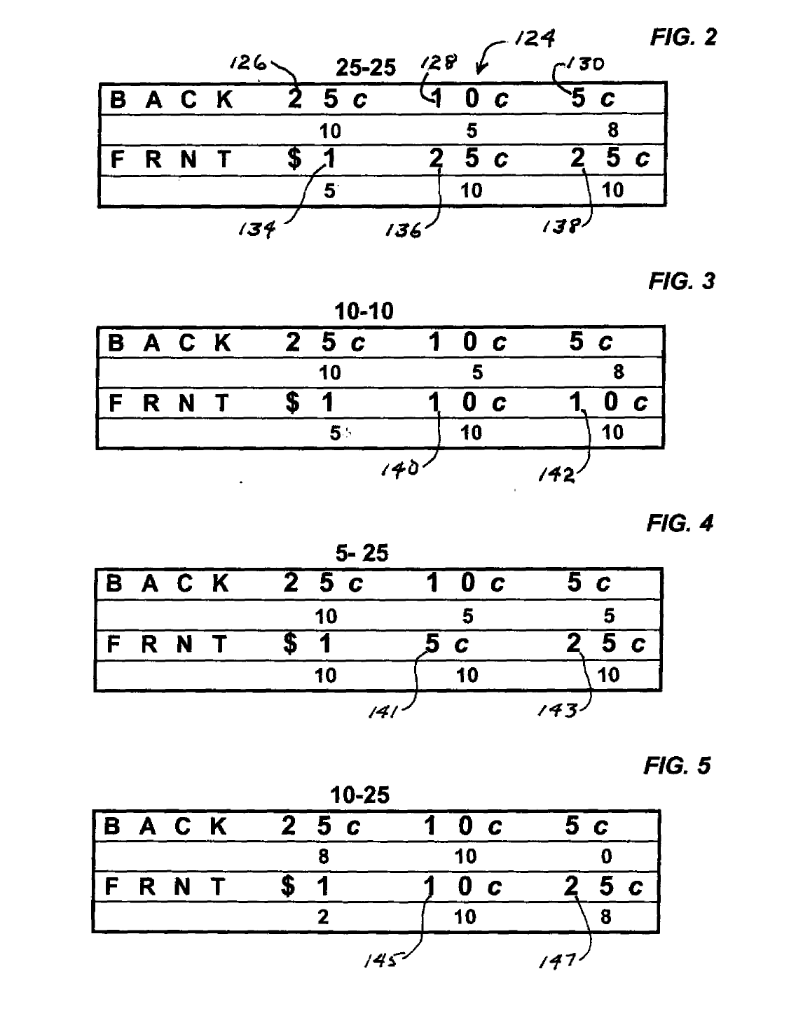

FIG. 2 shows a display presentation 124 recommending that the back three tube denominations 25c 126, 10c 128, and 5c 130 be filled to levels 10, 5, and 8 respectively, as shown and the front three denominations $1 134, 25c 136, and 25c 138 to be filled to levels 5, 10, and 10 respectively, as shown. In the like manner FIG. 3 shows the same recommendation for all the tubes as in FIG. 2 except 10c 140 to be filled to level 10, and 10c 142 to be filled to level 10 as shown. FIG. 4 shows a second 5c 141 denomination and a second 25c 143 denomination to be added for other price points. FIG. 5 shows a second 10 cent 145 denomination and a second 25 cent 147 denomination to be added for still other price points.

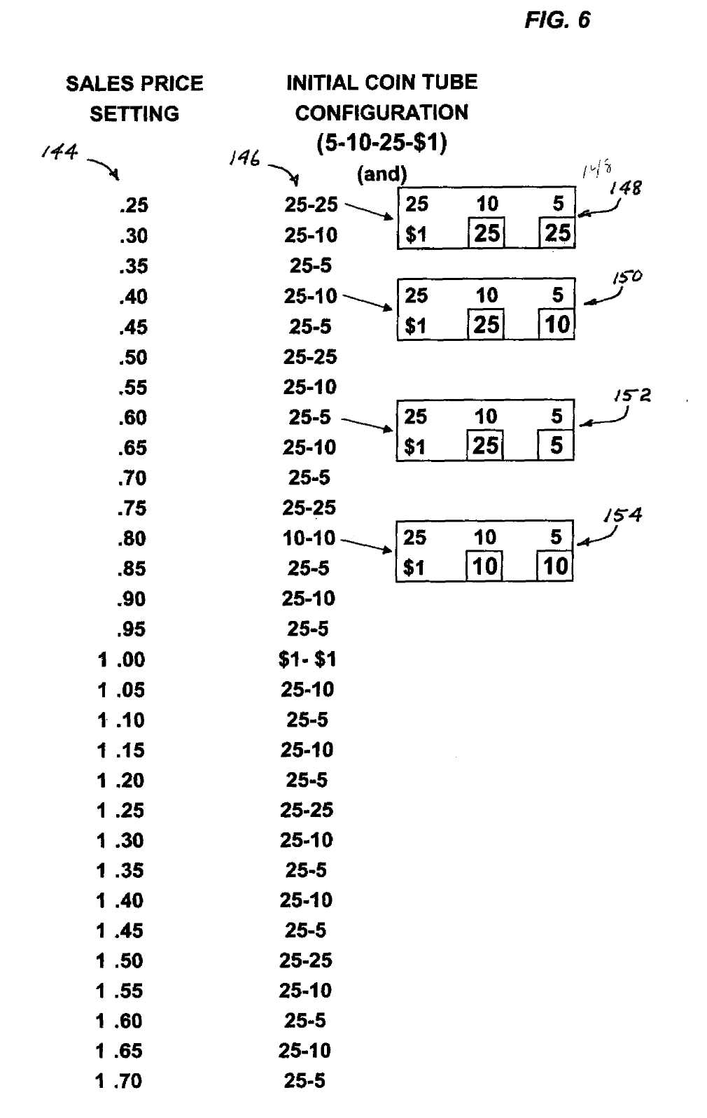

FIG. 6 shows an initial coin store assignment for denominations when six coin stores are available for dispensing and receiving coins. The sales price listing in column 144 is used for reference to column 146 wherein the different sales prices have recommended denominations for assignment to the coin stores. The denomination and operating level assigned each coin store is determined by the change making requirements for products at given price points, the capacity of the vending machine, the amount of sales activity expected, and the time interval for restocking. Outlined sketches 148, 150, 152, and 154 show a few possible denomination assignments of coin stores for a coin changer having six coin stores.

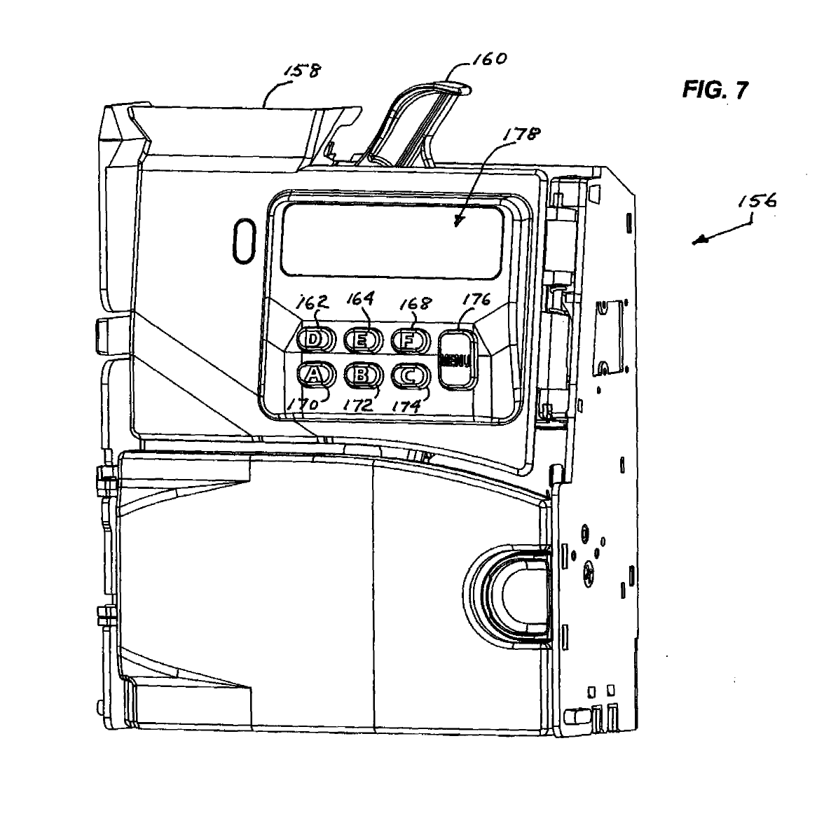

FIG. 7 shows a view of a coin acceptor 156 used for receiving coins at its entry funnel 158, having a coin escrow lever 160 for returning coins deposited, operator activated buttons 162, 164, 168, 170, 172, 174, and 176 for selected functions. A visual display 178 is used to show the operator the various information requested, such as the assignment of coin stores to the denomination to be used, and the place to position the level indicators 112 through 122 of FIG. 1. The buttons are also used to manually discharge coin stores, to reset coin store operating levels to zero, and to enter and review stored data.

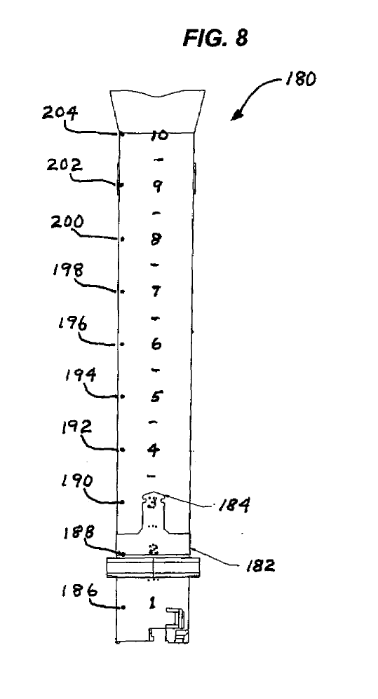

FIG. 8 shows the coin store 180 with its movable level indicator 182 having its pointer 184 which is positioned with reference to the lowest marking 1 186 through the topmost marking 10 204 in accordance with the visual display 178 of FIG. 7.

An operator will only use the display 178 to check the recommended levels for manually filling and discharging the coin stores. With the coin store level indicators 112 through 122 positioned correctly at each coin store, this method will be simple to compare when doing a quick check of the existing coin levels to those previously indicated.

The actual number of coins that are present at any marked level on the coin stores depends mainly on the thickness of the denomination of the coins therein. The accuracy of this factor is mainly determined by the very slight variance in coin thickness of the particular denomination and the total number of coins. The same is true when coins are added or removed while power is off and later sensed by determining the location of the top of the coin stack using sonic or other type of sensing. This variance might be plus or minus one coin depending how thin the denomination is and how tall the coin stack is. Using the general population average for the denomination thickness practically removes the slight variance.

Tracking the degree of coin usage over time at a particular location at a sales price point provides a displayable recommendation for the operator when requested. Manually indicating a total value of coins to be reduced or increased from a present operating level of zero has been described. An audio device used in a tube sensing system such as disclosed in U.S. patent application Ser. No. 11/234,909, entitled TUBE STATUS SENSING AND CONTROL”, can be used to audibly signify completion for any step, or for purposes of prompting. The contents of said application is incorporated herein by reference.

The forgoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by the details of the embodiments presented in this description. The above specification, examples, and data provide a complete description of the manufacture and use of the invention. Many embodiments of the invention can be made without departing from the spirit and scope of the invention.

What is claimed is:

1. A method of operating a coin changer comprising the steps of:
activating a visual display to show recommended operating levels for a plurality of coin stores; and
manually positioning level indicators associated with each of the plurality of coin stores to suggested operating levels displayed on the visual display.

2. The method of claim 1 further comprising the step of activating a visual display to show recommended coin store denominations for each of the plurality of coin stores.

3. The method of claim 1 further comprising the step of manually discharging or depositing coins with the plurality of coin stores to the level indicated by said level indicators.

4. The method of claim 1 further comprising the step of manually resetting the recommended coin store operating levels to a zero starting point.

5. A method of resetting one or more coin store operating levels in a coin changer comprising the steps of:
an operator manually indicating a total coin value to be discharged; and
a coin changer automatically discharging sequentially one coin at a time from one or more coin stores until said total value to be discharged is accomplished.

6. The method of claim 5 further comprising the step of resetting each coin store operating level to a zero starting point.

7. A method of manually resetting one or more coin store operating levels in a coin changer comprising the steps of:
an operator manually indicating a total coin value to be added; and
accepting deposited coins to one or more coin stores in a sequential order, one coin at a time until said total value to be added is reached.

8. The method of claim 7 further comprising the steps of resetting said coin store operating level to a zero starting point.

9. A method of determining the total value of coins to be added or removed in a coin changer, comprising:
manually depressing one or more buttons to display a value to be added or removed;
sensing the present coin store level for each of the plurality of coin stores;
comparing the difference between the displayed value and a present coin store level for each of the plurality of coin stores; and
displaying said total value of coins to be added or removed for each of the plurality of coin stores.

10. The method of claim 9 where the step of sensing is sensed acoustically.

11. A method of providing recommended coin store denominations and operating levels in a coin changer having a visual display, comprising the steps of:
determining stored recommended coin denomination proportions for a given sales price to be used;
determining the number of coin stores to be assigned for each denomination;
computing the operating levels for the coin stores to be used for coin dispensing based on a total value requirement; and
displaying each recommended coin store level.

12. The method of claim 11 further comprising the steps of manually positioning the level indicators attached to the coin stores to the displayed coin store level.

13. The method of claim 12 further comprising the steps of setting the new float levels of zero start points for each store from the displayed recommended coin store levels.
